(19) United States
(12) Patent Application Publication
(10) Pub. No.: US 2023/0130820 A1
(43) Pub. Date: Apr. 27, 2023

(54) METHOD OF MANUFACTURING HEATING ELEMENTS FOR VEHICLE INTERIOR MATERIALS

(71) Applicant: SEOYON E-HWA CO., LTD., Anyang (KR)

(72) Inventor: Tae In PARK, Anyang (KR)

(21) Appl. No.: 18/048,441

(22) Filed: Oct. 21, 2022

(30) Foreign Application Priority Data
Oct. 26, 2021 (KR) 10-2021-0143686

(51) Int. Cl. H05B 3/18; H05B 3/12; B29C 43/02; B29C 43/14

(52) U.S. Cl. CPC H05B 3/18; H05B 3/12; B29C 43/021; B29C 43/14; H05B 2203/017; B29L 2031/779

(57) ABSTRACT

Disclosed herein is a method of manufacturing heating elements for vehicle interior materials, which includes forming a base part having the same shape as a curved surface of a subject, forming an electrode part on an upper surface of the base part, and stacking a heating part on upper surfaces of the base part and electrode part. Accordingly, the heating element is manufactured in advance to have the same shape as the curved surface of the subject and then adhered to the subject so that the heating element is overlapped on and pressed against the subject without deformation. Thus, it is possible to make overall temperature distribution uniform and improve product quality.

### BACKGROUND

### 1. Technical Field

The present disclosure relates to a method of manufacturing heating elements for vehicle interior materials, and more particularly, to a method of manufacturing a heating element that is mounted on an interior material of a vehicle to generate heat by electric energy.

### 2. Related Art

A heater using radiant heat is used in parallel in a vehicle since heating by an air conditioning system therein takes a considerable amount of time to increase the temperature inside the vehicle.

Moreover, a radiant heater using electricity as an energy source is applied to an electric vehicle that cannot use engine heat due to no internal combustion engine mounted thereto.

In recent years, technology has been actively developed for mounting and using a radiant heater on vehicle interior materials (e.g., a shroud, a door trim, a pillar trim, a console, a headliner, a crash pad, a luggage trim, etc.).

Examples of a heat source of such a radiation heater include a linear heating element using a hot wire and a planar heating element using a heating layer in the form of a film (flexible surface).

However, since the linear heating element uses a heating pad with a built-in hot wire, it is inevitably thicker than the planar heating element and it is difficult to apply the linear heating element to a complex curved shape when applied to a vehicle.

Therefore, the planar heating element is widely used rather than the linear heating element.

As illustrated in FIG. 1, a conventional heating element for vehicle interior materials 100 includes a base part 101, an electrode 102 formed on the upper surface of the base part 101, a heating part 103 stacked on the upper surface of the base part 101 for electrical connection to the electrode part 102, and a coverlay 104 stacked on the upper surfaces of the heating part 103 and base part 101. A human body sensor (not shown) may be further formed on the upper surface of the base part 101 as well as the electrode part 102. When a control unit (not shown) receives a signal from the human body sensor and determines that a human body approaches or comes into contact with a radiant heater equipped with the conventional heating element for vehicle interior materials 100, the radiation heater cuts off the power applied to the electrode part 102 or reduces the amount of current applied thereto to decrease the temperature of the heating part 103, thereby protecting the human body from the risk of burns.

In this case, the conventional heating element for vehicle interior materials 100 is applied to a flat surface or a two-dimensional curved surface by forming the heating part 103 to have a uniform thickness (in the heating part 103, the portion connected to the electrode part 102 may be slightly thinner or thicker than other portions), namely, to have a flat upper surface.

However, as illustrated in FIG. 2, when the conventional heating element for vehicle interior materials 100 is attached to a subject S (a vehicle interior material which may be a substrate such as a shroud, a door trim, a pillar trim, a console, a headliner, a crash pad, or a luggage trim), the shape of which is a three-dimensional curved surface, the heating element is stretched from the bent portion thereof so that the stretched portion A of the heating element becomes thinner than the flat portion B thereof. In this case, as the stretched portion A of the heating part 103 becomes thinner than the flat portion B thereof, the overall heating temperature is non-uniform, which causes discomfort to a user and results in a deterioration in performance of the heater structure including the conventional heating element for vehicle interior materials 100.

Moreover, the conventional heating element for vehicle interior materials 100 is wrinkled or has a lifting phenomenon because it is not perfectly pressed against the three-dimensional curved surface of the subject S, which eventually causes product failure.

The foregoing is intended for technical information possessed for derivation of the present disclosure or acquired in the process of derivation thereof by the inventor, which is not necessarily a known technique disclosed to the general public prior to the filing of the invention.

### PATENT DOCUMENT

(Patent Document 1) Korean Patent No. 10-1567218 (Nov. 2, 2015)

### SUMMARY

Various embodiments are directed to a method of manufacturing heating elements for vehicle interior materials, which manufactures a heating element in the same shape as a curved surface of a subject in advance and then adheres it to the subject so that the heating element is overlapped on and pressed against the subject without deformation, thereby making overall temperature distribution uniform and improving product quality.

The present disclosure is not limited to the above-mentioned object, and other objects of the present disclosure will be clearly understood by those skilled in the art to which the present disclosure pertains from the following description.

In accordance with an aspect of the present disclosure, there is provided a method of manufacturing heating elements for vehicle interior materials, which includes forming a base part having the same shape as a curved surface of a subject, forming an electrode part on an upper surface of the base part, and stacking a heating part on upper surfaces of the base part and electrode part.

In the forming a base part, the base part may be formed by a mold with a cavity surface having the same shape as the surface of the subject.

In the forming an electrode part, the electrode part may be formed in a state in which the base part formed in the forming a base part is seated on a jig with a surface having the same shape as the surface of the subject.

In the forming an electrode part, the electrode part may be printed by applying a conductive ink to a first soft pad.

The first pad may have a lower surface formed to have the same curvature as a curved surface of the base part to be printed.

In the forming an electrode part, the first pad may consist of a plurality of first pads used depending on the shape of the subject, and the electrode part may be divided into a plurality of pieces for printing.

The method of manufacturing heating elements for vehicle interior materials may further include drying the printed electrode part.

In the stacking a heating part, the heating part may be printed by applying a heating ink to a second soft pad.

The second pad may have a lower surface formed to have the same curvature as a curved surface of the base part to be printed.

In the stacking a heating part, the second pad may consist of a plurality of second pads used depending on the shape of the subject, and the heating part may be divided into a plurality of pieces for printing.

The method of manufacturing heating elements for vehicle interior materials may further include drying the printed heating part.

The method of manufacturing heating elements for vehicle interior materials may further include forming a coverlay by covering a coverlay film on upper surfaces of the heating part and base part in a state in which the base part on which the electrode part and the heating part are printed is seated in the mold with the cavity surface having the same shape as the surface of the subject.

In the forming a coverlay, the coverlay film may be attached to the upper surfaces of the heating part and base part by hot pressing.

The method of manufacturing heating elements for vehicle interior materials may further include cutting outer lines of the base part and coverlay.

As is apparent from the above description, the method of manufacturing heating elements for vehicle interior materials can manufacture the heating element in the same shape as the curved surface of the subject in advance and then adhere it to the subject so that the heating element is overlapped on and pressed against the subject without deformation. Thus, it is possible to make overall temperature distribution uniform and improve product quality.

The present disclosure is not limited to the above-mentioned effect, and other effects of the present disclosure will be clearly understood by those skilled in the art to which the present disclosure pertains from the following description.

### BRIEF DESCRIPTION OF THE DRAWINGS

FIG. 1 is a cross-sectional side view schematically illustrating a conventional heating element for vehicle interior materials.

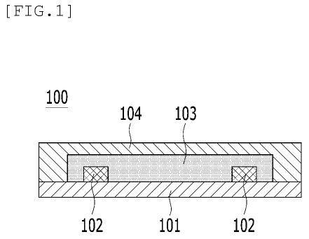

FIG. 2 is a cross-sectional side view schematically illustrating a state in which the heating element for vehicle interior materials in FIG. 1 is applied to a subject.

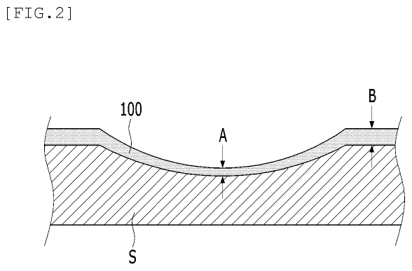

FIG. 3 is a flowchart schematically illustrating a method of manufacturing heating elements for vehicle interior materials according to an embodiment of the present disclosure.

FIG. 4 is a schematic conceptual view for explaining the method of manufacturing heating elements for vehicle interior materials in FIG. 3.

FIG. 5 is a cross-sectional side view schematically illustrating an example of a heating element for vehicle interior materials manufactured according to the method of manufacturing heating elements for vehicle interior materials in FIG. 3.

### DETAILED DESCRIPTION

The accompanying drawings in the present disclosure may have been exaggerated for differentiation and clarity from the prior art and for the sake of understanding the technology. In addition, the terms used in the specification are terms defined in consideration of functions of the present disclosure, and these terms may change depending on the intention or practice of a user or an operator. Therefore, these terms should be defined based on the overall disclosures set forth herein. Meanwhile, the following embodiments are merely for the purpose of describing the components set forth in the appended claims and are not intended to limit the spirit and scope of the disclosure.

Throughout the specification, it will be understood that, when a component is referred to as “comprising” or “including” any component, it does not exclude other components, but can further comprise or include the other components unless otherwise specified.

In addition, it will be understood that, when a component is referred to as being “connected”, “joined”, or “coupled” to another component, it can be “directly connected”, “directly joined”, or “directly coupled” to the other component or it can be “indirectly connected”, “indirectly joined”, or “indirectly coupled” to the other component with other components being interposed therebetween. On the other hand, it will be understood that, when a component is referred to as being “directly connected”, “directly joined”, or “directly coupled” to another component, no intervening components are present.

In addition, when directional terms such as “before”, “after”, “up”, “down”, “left”, “right”, “one end”, “other end”, and both ends” are used, these terms should not be construed as limiting as they are used by way of example in relation to the orientation in the drawings disclosed herein. As used herein, the terms such as “first” and “second” should not be construed as limiting terms for distinguishing each component.

In order to more clearly describe features of embodiments of the present disclosure, a detailed description of matters widely known to those skilled in the art to which the following embodiments pertain will be omitted. In addition, a detailed description of parts irrelevant to the embodiment and description in the drawings will be omitted.

Hereinafter, exemplary embodiments of the present disclosure will be described in detail with reference to the accompanying drawings.

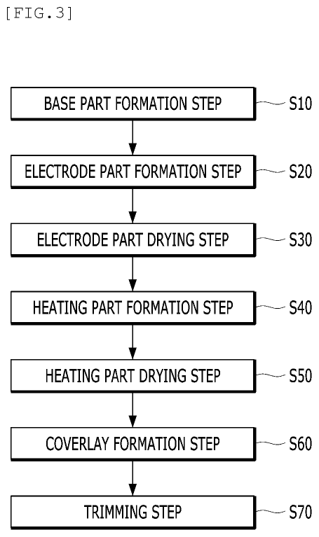

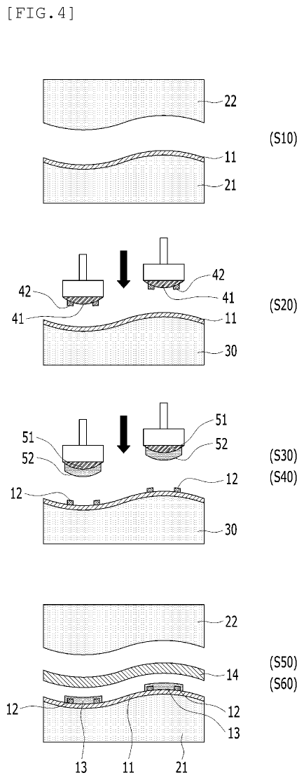

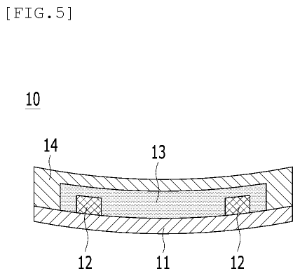

FIG. 3 is a flowchart schematically illustrating a method of manufacturing heating elements for vehicle interior materials according to an embodiment of the present disclosure. FIG. 4 is a schematic conceptual view for explaining the method of manufacturing heating elements for vehicle interior materials in FIG. 3. FIG. 5 is a cross-sectional side view schematically illustrating an example of a heating element for vehicle interior materials manufactured according to the method of manufacturing heating elements for vehicle interior materials in FIG. 3.

Referring to FIGS. 3 to 5, the method of manufacturing heating elements for vehicle interior materials according to the embodiment of the present disclosure includes a base part formation step S10, an electrode part formation step S20, and a heating part formation step S40.

In this case, the method of manufacturing heating elements for vehicle interior materials according to the embodiment of the present disclosure may further include at least one of an electrode part drying step S30, a heating part drying step S50, a coverlay formation step S60, and a trimming step S70.

The base part formation step S10 is a step of forming a base part 11 in the same shape as the curved surface of a subject.

In the base part formation step S10, the base part 11 may be formed by a mold with a cavity surface having the same shape as the surface of the subject.

In more detail, in the base part formation step S10, the base part 11 is formed using a press mold. The press mold is for a hot press process, and includes an upper mold 22 and a lower mold 21, which each have a cavity surface having the same shape as the surface of the subject.

As such, since the cavity surfaces of the lower mold 21 and upper mold 22 for forming the base part 11 have the same shape as the three-dimensional curved surface of the subject, the base part 11 may also have the same shape as the three-dimensional curved surface of the subject. Accordingly, a heating element for vehicle interior materials 10 manufactured by the method of manufacturing heating elements for vehicle interior materials according to the embodiment of the present disclosure may be overlapped on and pressed against the subject without bending and deformation when attached thereto, unlike the prior art.

The base part 11 may be attached to the subject (a vehicle interior material which may be a substrate such as a shroud, a door trim, a pillar trim, a console, a headliner, a crash pad, or a luggage trim).

The base part 11 may be attached to the subject through an adhesive layer.

The base part 11 may be made of a material such as polyimide (PI), polyethyleneterephthalate (PET), or polyethylenenaphthalate (PEN), but is not limited thereto.

The base part 11 is manufactured in the form of a film and has a structure in which the following other components may be stacked thereon.

The electrode part formation step S20 is a step of forming an electrode part 12 on the upper surface of the base part 11.

In the electrode part formation step S20, the electrode part 12 may be formed by printing in a state in which the base part 11 formed in the base part formation step S10 is seated on a jig 30 with a surface having the same shape as the surface of the subject.

The jig 30 may be provided separately from the lower mold 21, or may intactly use the lower mold 21 with a cavity surface having the same shape as the surface of the subject. When the jig 30 provided separately from the lower mold 21 is used, the electrode part 12 is formed after the base part 11 is moved from the lower mold 21 and seated on the jig 30. When the lower mold 21 is used as the jig 30, the electrode part 12 is formed in a state in which the base part 11 is seated on the cavity surface of the lower mold 21 after removal of the upper mold 22.

When the base part formation step S10 and the electrode part formation step S20 are continuously performed in the same space, it may be advantageous to use the lower mold 21 as it is. When there is a considerable time interval between the base part formation step S10 and the electrode part formation step S20 or both steps are performed in a separate space, the jig 30 manufactured separately may be used. Hereinafter, the jig 30 is defined as including the lower mold 21 in addition to being manufactured separately.

Meanwhile, in the electrode part formation step S20, the electrode part 12 may be printed by applying a conductive ink 42 to a first soft pad 41.

In detail, in the electrode part formation step S20, the first pad 41 made of a soft material is used to print the electrode part 12 on the base part 11 because the base part 11 has the same three-dimensional curved shape as the subject. The first pad 41 may be made of a rubber or silicone material.

Although FIG. 4 illustrates that the first pad 41 has a convex lower surface, it is more preferable that the lower surface of the first pad 41 have the same curvature as the three-dimensional curved surface of the base part 11 to be printed. That is, the lower surface of the first pad 41 may be convexly or concavely formed to have approximately the same curvature corresponding to the three-dimensional curved surface of the base part 11.

The first pad 41 is made of a soft material. Therefore, the conductive ink 42 on the first pad 41 may be printed on the upper surface of the base part 11 while the first pad 41 is deformed in shape when it is in contact with the upper surface of the base part 11 for printing. That is, the electrode part 12 is printed and formed on the upper surface of the base part 11 by applying the conductive ink 42 to the lower surface of the first pad 41 and then moving the first pad 41 down to come into contact with and apply pressure to the upper surface of the base part 11 for printing.

In this case, in the electrode part formation step S20, the first pad 41 may consist of a plurality of first pads used depending on the shape of the subject, and the electrode part 12 may be divided into a plurality of pieces for printing. That is, in a portion where the curvature of the three-dimensional curved surface of the subject exceeds a deformation limit of one of the first pads 41, the first pad 41 having a different curvature applicable to that curvature range may be provided separately and the electrode part 12 may be divided into a plurality of sections for printing. This method is advantageous to uniformly form the printed thickness of the electrode part 12.

The conductive ink 42 is composed of silver (Ag) or copper (Cu) as a main raw material. The conductive ink 42 is in the form of a paste and is applied to the first pad 41 for use.

In the heating element for vehicle interior materials 10 manufactured by the method of manufacturing heating elements for vehicle interior materials according to the embodiment of the present disclosure, the electrode part 12 serves to apply power to a heating part 13.

The electrode part 12 may be connected to a separate power source (not shown) and/or a control unit (not shown).

Meanwhile, a human body sensor (not shown) as well as the electrode part 12 may be further formed in the same manner as the electrode part 12.

The electrode part drying step S30 is a step of drying the printed electrode part 12. That is, the electrode part drying step S30 is a step in which, when the electrode part 12 has been printed on the upper surface of the base part 11 in the electrode part formation step S20, the conductive ink 42 forming the electrode part 12 is dried at a high temperature.

In the electrode part drying step S30, the conductive ink 42 printed on the base part 11 may be dried by heating the jig 30. Here, the jig 30 has a heating mechanism (not shown) therein to dry the conductive ink 42 by increasing the temperature of the cavity surface of the jig 30, thereby completing the electrode part 12.

The heating part formation step S40 is a step of stacking the heating part 13 on the upper surfaces of the base part 11 and electrode part 12 when the electrode part 12 is dried in the electrode part drying step S30. In the heating part formation step S40, the jig 30 is used as it is.

In the heating part formation step S40, the heating part 13 may be printed by applying a heating ink 52 to a second soft pad 51.

In detail, in the heating part formation step S40, the second pad 51 made of a soft material is used to print the heating part 13 on the base part 11 because the base part 11 has the same three-dimensional curved shape as the subject. The second pad 51 may be made of a rubber or silicone material.

Although FIG. 4 illustrates that the second pad 51 has a convex lower surface, it is more preferable that the lower surface of the second pad 51 have the same curvature as the three-dimensional curved surface of the base part 11 to be printed. That is, the lower surface of the second pad 51 may be convexly or concavely formed to have approximately the same curvature corresponding to the three-dimensional curved surface of the base part 11.

The second pad 51 is made of a soft material. Therefore, the heating ink 52 on the second pad 51 may be printed on the upper surfaces of the base part 11 and electrode part 12 while the second pad 51 is deformed in shape when it is in contact with the upper surfaces of the base part 11 and electrode part 12 for printing. That is, the heating part 13 is printed and formed on the upper surfaces of the base part 11 and electrode part 12 by applying the heating ink 52 to the lower surface of the second pad 51 and then moving the second pad 51 down to come into contact with and apply pressure to the upper surfaces of the base part 11 and electrode part 12 for printing.

In this case, in the heating part formation step S40, the second pad 51 may consist of a plurality of second pads used depending on the shape of the subject, and the heating part 13 may be divided into a plurality of pieces for printing. That is, in a portion where the curvature of the three-dimensional curved surface of the subject exceeds a deformation limit of one of the second pads 51, the second pad 51 having a different curvature applicable to that curvature range may be provided separately and the heating part 13 may be divided into a plurality of sections for printing. This method is advantageous to uniformly form the printed thickness of the heating part 13.

The heating ink 52 is composed of a carbon nanotube (CNT) or the like (e.g., a conductive material such as silver or copper) as a main raw material. The heating ink 52 is in the form of a paste and is applied to the second pad 51 for use.

In the heating element for vehicle interior materials 10 manufactured by the method of manufacturing heating elements for vehicle interior materials according to the embodiment of the present disclosure, the heating part 13 is configured such that both ends thereof come into contact with the respective anode and cathode of the electrode part 12 for electrical connection. This allows the heating part 13 to act as a resistor, which electrically connects the anode and the cathode of the electrode part 12, when electric power is applied to the electrode part 12, thereby generating heat.

The heating part 13 may be made of a material such as a carbon nanotube (CNT), but is not limited thereto. For example, the heating part 13 may be made of a conductive material such as copper or silver and may be in the form of a paste.

The heating part drying step S50 is a step of drying the printed heating part 13. That is, the heating part drying step S50 is a step in which, when the heating part 13 has been printed on the upper surfaces of the base part 11 and electrode part 12 in the same manner as in the electrode part drying step S30 in the heating part formation step S40, the heating ink 52 forming the heating part 13 is dried at a high temperature.

In the heating part drying step S50, the heating ink 52 on the base part 11 and the electrode part 12 may be dried by heating the jig 30. Here, the jig 30 has a heating mechanism (not shown) therein to dry the heating ink 52 by increasing the temperature of the cavity surface of the jig 30, thereby completing the heating part 13.

The heating part drying step S50 may be performed in either of the jig 30 or the lower mold 21. As described above, the jig 30 may have the same configuration as the lower mold 21.

The coverlay formation step S60 is a step of, when the heating part 13 is dried in the heating part drying step S50, forming a coverlay 14 by covering a coverlay film on the upper surfaces of the heating part 13 and base part 11 in a state in which the base part 11 on which the electrode part 12 and the heating part 13 are printed is seated in the mold with a cavity surface having the same shape as the surface of the subject. (If the heating part 13 is configured to cover only a portion of the upper surface of the electrode part 12, the coverlay 14 may further include a structure that covers the electrode part 12 while in contact therewith.)

In the coverlay formation step S60, the coverlay film may be attached to the upper surfaces of the heating part 13 and base part 11 by hot pressing. In detail, in the coverlay formation step S60, in a state in which the base part 11 on which the electrode part 12 and the heating part 13 are printed is seated on the lower mold 21, the coverlay 14 manufactured in advance may be covered and attached by hot pressing using the upper mold 22.

The coverlay 14 may be manufactured in advance by a hot press process in the same manner as in the base part formation step S10. In this case, the coverlay 14 may be manufactured in a flat form, or may be manufactured in advance in the same shape as the three-dimensional curved surface of the subject, like the base part 11.

In the heating element for vehicle interior materials 10 manufactured by the method of manufacturing heating elements for vehicle interior materials according to the embodiment of the present disclosure, the coverlay 14 may have a structure that covers a portion of the electrode part 120 as well as the heating part 13 and the base part 11, and may be stacked on each component through an adhesive layer.

In addition, a fabric (not shown) in contact with a user's skin may be attached to the outside of the coverlay 14 through an adhesive layer.

The coverlay 14 may be made of a material such as polyimide (PI), polyethyleneterephthalate (PET), or polyethylenenaphthalate (PEN), but is not limited thereto.

The trimming step S70 is a step of cutting the outer lines of the base part 11 and coverlay 14 after the coverlay 14 is formed in the coverlay formation step S60.

In the trimming step S70, the product may be completed by cutting the outer lines of the base part 11 and coverlay 14 exposed out of the upper and lower molds 22 and 21 in a state in which the coverlay 14 is hot-pressed in the cavities of the upper and lower molds 22 and 21.

As described above, the method of manufacturing heating elements for vehicle interior materials can manufacture the heating element in the same shape as the curved surface of the subject in advance and then adhere it to the subject so that the heating element is overlapped on and pressed against the subject without deformation. Thus, it is possible to make overall temperature distribution uniform and improve product quality.

While the present disclosure has been described with respect to the embodiments illustrated in the drawings, it will be obvious to those skilled in the art that such embodiments are provided by way of example only. It will be understood by those skilled in the art that various modifications and other equivalent embodiments may be made without departing from the spirit and scope of the disclosure as defined in the following claims. Therefore, the true technical protection scope of the present disclosure should be defined by technical concepts of the appended claims.

The present disclosure relates to a method of manufacturing heating elements for vehicle interior materials, which can be used in industrial applications related to vehicle interior materials.

What is claimed is:

1. A method of manufacturing heating elements for vehicle interior materials, comprising:
forming a base part having the same shape as a curved surface of a subject;
forming an electrode part on an upper surface of the base part; and
stacking a heating part on upper surfaces of the base part and electrode part.

2. The method according to claim 1, wherein, in the forming a base part, the base part is formed by a mold with a cavity surface having the same shape as the surface of the subject.

3. The method according to claim 2, wherein, in the forming an electrode part, the electrode part is formed in a state in which the base part formed in the forming a base part is seated on a jig with a surface having the same shape as the surface of the subject.

4. The method according to claim 3, wherein, in the forming an electrode part, the electrode part is printed by applying a conductive ink to a first soft pad.

5. The method according to claim 3, wherein the first pad has a lower surface formed to have the same curvature as a curved surface of the base part to be printed.

6. The method according to claim 4, wherein, in the forming an electrode part, the first pad consists of a plurality of first pads used depending on the shape of the subject, and the electrode part is divided into a plurality of pieces for printing.

7. The method according to claim 4, further comprising drying the printed electrode part.

8. The method according to claim 3, wherein, in the stacking a heating part, the heating part is printed by applying a heating ink to a second soft pad.

9. The method according to claim 8, wherein the second pad has a lower surface formed to have the same curvature as a curved surface of the base part to be printed.

10. The method according to claim 8, wherein, in the stacking a heating part, the second pad consists of a plurality of second pads used depending on the shape of the subject, and the heating part is divided into a plurality of pieces for printing.

11. The method according to claim 8, further comprising drying the printed heating part.

12. The method according to claim 11, further comprising forming a coverlay by covering a coverlay film on upper surfaces of the heating part and base part in a state in which the base part on which the electrode part and the heating part are printed is seated in the mold with the cavity surface having the same shape as the surface of the subject.

13. The method according to claim 12, wherein, in the forming a coverlay, the coverlay film is attached to the upper surfaces of the heating part and base part by hot pressing.

14. The method according to claim 12, further comprising cutting outer lines of the base part and coverlay.
